(19) United States
(12) Patent Application Publication
(10) Pub. No.: US 2007/0265922 A1
(43) Pub. Date: Nov. 15, 2007

(54) Dealership inventory display through interactive banner ads

(76) Inventors: David I. Dumond, Cincinnati, OH (US); David H. Hudepohl, Ft.Thomas, KY (US)

Correspondence Address: FirstAuto, Inc.;ATTN : Sandy Moeller, 6435 Centre Park Drive, West Chester, OH, 45069, US

(21) Appl. No.: 11/801,761

(22) Filed: May 11, 2007

Related U.S. Application Data
(60) Provisional application No. 60/800,264, filed on May 15, 2006.

(51) Int. Cl. G06Q 30/00

(52) U.S. Cl. 705/14

(57) ABSTRACT

An electronic advertisement method and system for delivering, via the Internet, a fully interactive database of vehicle inventory contained within a Banner Advertisement. A key strength of the invention is that it takes an existing commercial infrastructure—the banner ad—and it greatly enhances its value to the marketplace. The invention makes it possible for a user to easily and efficiently browse inventory of cars for sale, including photos, within the banner advertisement itself without obstructing the viewing and reading of other website content. This benefits both the viewer as well as the advertiser. The Interactive Inventory banner advertisement system provides a novel method of inserting inventory into any web page banner as well as a novel method for consumers to interact with car classifieds.

### CROSS-REFERENCE TO RELATED APPLICATIONS

U.S. Patents

| | | |
|---|---|---|
| 7,158,942 | January, 2007 | Miyazaki, et al. |
| 7,165,039 | January, 2007 | Seet, et al. |
| 7,194,425 | March, 2007 | Nyahn, et al. |

A provisional patent application for this invention was filed on May 15, 2006, and has been assigned the following application No. 60/800,264

### FIELD OF THE INVENTION

The Invention is in the field of electronic marketing via the Internet.

### STATEMENT REGARDING FEDERALLY SPONSORED RESEARCH OR DEV.

Not Applicable.

### BACKGROUND OF THE INVENTION

Prior to the Invention, car dealerships could not market an extensive and up-to-date vehicle inventory to consumers through a banner advertisement. Likewise, consumers could not view extensive and up-to-date dealer inventory through a banner advertisement. Banner advertisements were static images, or, if they contained any functionality at all such a search box, it was merely a bait tactic that would take the consumer away from one website to another website. The invention significantly enhances marketplace efficiencies because now consumers can search through dealership inventory via a banner advertisement without ever leaving the site they are on, whether it be a news site, a community site, or a blog. Prior to the invention, consumers had to click away from their primary activity (by selecting an ad, for example) in order to search through an inventory-rich site (either the dealership's own website (“www.dealername.com”) or an aggregator such as www.Cars.com or www.Autotrader.com). By virtue of the Invention, consumers do not disengage from the website they are currently visiting. They can search vehicle inventory within the context of their current activity (reading about sports, weather, blogs, etc.) In addition, dealerships can now bring useful information to consumers at the most likely places where they dwell online (such as news and weather pages), and dealerships can do so with a significantly better alternative to static ads.

### BRIEF SUMMARY OF THE INVENTION

The invention is a searchable banner advertisement that displays a dealership's current and complete vehicle inventory, including photos, directly in the banner itself. The banner advertisement contains an interactive application that can be placed on any other website and a consumer may directly interact with banner ad in order to search inventory and view a vehicle's details and photos. Also, the consumer can send an inquiry directly to the dealership through the banner advertisement's sales inquiry form. The Invention creates a new paradigm for the banner ad because it brings a complex, searchable database to the consumer's preferred environment in a utility that maximizes opportunity for the car dealership (more exposure at higher quality), the web publisher (greatly enhances the publisher's “real estate”), and the consumer (saves time and delivers key information, what's for sale).

### DETAILED DESCRIPTION OF THE INVENTION

In the preferred embodiment, a web publisher such as a TV station website, a radio station website, a news site, or an online automotive magazine displays the invention in the same manner that it would display a typical banner advertisement that promotes a car dealership. Prior to the invention, the standard banner advertisement showed a graphic (either static or animated) that served as a billboard for the dealership brand. That is to say, the banner advertisement promoted the brand of the dealership through a visual impression of the store's identity (e.g. store name, logo, special deal of the week) that typically appeared alongside text (such as a news story, an advice column, or a car review), above the text, or as a graphic insert within the body of text. If the consumer (end user) wanted to see more about the dealership or its offer, the consumer would then click on the banner graphic and this action would redirect the user to a new web page, either as a pop-up or as a change of address within the user's current web browser. The user would be made to disengage from his or her current activity—such as reading a local news story—in order to engage the content page linked to the banner advertisement. In many instances, this link would be a direct link to the dealership's own website, usually opening the home page of that website. The consumer would then have to burrow down into this website in order to view specific vehicle inventory details.

The invention enables a web publisher such as a TV station website to display a fully-interactive application within the banner advertisement itself, and this application gives consumers the ability to browse through the actual, current inventory of the advertising dealership. This inventory is accessible to the consumer directly from the web page the consumer is browsing. The consumer does not have to click away to the dealership home page, for instance, in order to see that store's actual listing of vehicles or to submit a sales inquiry to the dealership.

The invention is comprised of (1) a data aggregation technology that captures, parses, and normalizes the vehicle inventory information, (2) an inventory publishing engine that takes the inventory and presents it in a user-friendly format within the banner advertisement, and (3) a reporting system that captures sales inquiries and provides email updates regarding banner click performance to dealerships and web publishers.

Google-like search applications represent only the first and most obvious step of data organization and commercialization. The data acquisition and deployment technology of this invention exemplifies a next-generation approach to data intelligence. This invention's product-specific and market-unique offering demonstrates consumer benefit and commercial viability. Structuring disparate data such as dealership vehicle inventory into the easy-to-use aggregated solution of the Interactive Automotive Ad Banner makes sense for all parties involved: the consumer, the dealership, and the media partner/website publisher. This invention's data aggregation technology is a family of custom software applications that take any combination of unstructured data inputs (such as vehicle information from dealership websites, computers, mainframes, or manual input) and sanitizes this information so that it exists in a standard format for redistribution and consumer use.

The information is then published to the Internet through a display in html, xml, or other Internet data distribution formats. The preferred embodiment of the invention is a display of inventory within the conventional banner advertisement scheme, which is typically a rectangular display on a web page of various dimensions (such as 728×90 pixel leaderboard banners and 160×600 pixel skyscraper banners), though any banner ad size is possible. The invention enables the consumer to browse through a listing of a selection or all dealership vehicles currently for sale. The user can then click on a unique vehicle listing while browsing the dealership's complete inventory within the banner advertisement. Upon clicking on an individual vehicle for more detailed information, the user is presented with a Vehicle Display Ad that offers more equipment specifics, including an actual photo of the car when a photo is available. The consumer can also fill out a sales inquiry form at the Vehicle Display Ad, and this sales inquiry is emailed to the dealership. Alternatively, once a specific car link has been selected by the user, the Interactive Inventory banner invention may direct the user to that vehicle's web page at the dealership's website (a deep link), which saves the consumer time by taking him or her directly to that vehicle's full description page (normally, the consumer has to browse the dealership's website to find the specific car of interest). All of this vehicle selection interaction takes place without diverting the consumer away from his or her present activity at the publisher's site (reading a news story, for example).

The invention also has a reporting system that tracks the specific clicks for every stock number viewed within the dealership Interactive Inventory Banner Advertisement. This report provides the publisher and the dealership advertiser with detail regarding every time a banner is displayed and every time a stock number Vehicle Display Ad is viewed for any given time period (usually, a daily email report). Prior to the invention, publishers could only report on the number of banner ad impressions and click rate. The invention enables publishers to supply detailed information about consumer click activity tied to specific stock numbers in a dealership's vehicle inventory. Also, based on consumer interaction with the Inventory Banner Advertisement, the dealership can gain valuable insight into the exact cars that interest consumers via a specific web publisher.

What we claim as our invention is:

1. A method of integrating and displaying vehicle inventory within a banner advertisement, comprising steps of: identifying and aggregating said particular inventory; inserting said particular inventory content into an interactive banner advertisement display; dynamically publishing said banner advertisement display; reporting click activity and sales inquiries regarding specific vehicles to advertisers and publishers.

2. A system for aggregating and displaying vehicle inventory information within an interactive banner advertisement, comprising: a custom data collection software tool that compiles multi-source inventory information and translates it into a standardized, consumer-friendly format, a custom publishing software tool that takes said inventory and presents the vehicle information in Internet-ready, browsable data formats and banner advertisements of any size.
